(19) United States
(12) Patent Application Publication
(10) Pub. No.: US 2023/0158831 A1
(43) Pub. Date: May 25, 2023

(54) WHEEL-INTERNAL DOUBLE BEADLOCK SYSTEM AND METHODS THEREOF

(71) Applicant: ORIBI MANUFACTURING, Commerce City, CO (US)

(72) Inventor: Jack Frederick Wilfley, Commerce City, CO (US)

(21) Appl. No.: 17/534,107

(22) Filed: Nov. 23, 2021

(51) Int. Cl. B60B 21/12; B60B 21/04; B60B 21/10

(52) U.S. Cl. CPC B60B 21/125; B60B 21/04; B60B 21/104; B60B 2320/10

(57) ABSTRACT

An internal double beadlock system includes a centralized inner ring and one or more tire positioners. The one or more tire positioners are coupled to extend out from each side of the centralized inner ring. Each of the tire positioners has a length to detachably engage with a portion of an inner tire wall on each side of a tire positioned on a tire rim while being shorter than a width of the tire rim.

### FIELD

This technology generally relates to tire beadlock systems and, more particularly, to wheel-internal double beadlock systems and methods thereof

### BACKGROUND

All vehicle wheels use some version of a “beadlock” system. Tires and wheels are designed so that when the tire is inflated, the tire pressure pushes the bead of the tire against the inside of the wheel rim so that the tire stays on the wheel and the two rotate together. The beadlock system is designed to keep the tire in place on the wheel in situations when air pressure is intentionally or unintentionally insufficient, i.e. low or no air pressure, to hold the bead of the tire in place. For example, in certain driving situations, such as certain types of off-roading, drivers may want extremely low tire pressure for traction or other reasons.

As such, there are numbers of prior designs of beadlock systems. The most common is a “bump” B1 and B2 adjacent each side on the wheel rim TR1, that requires high air pressure to overcome, and “pop” the tire over as shown in traditional beadlock system illustrated in FIG. 1. Once the side of the tire is over the bump B1 and B2 on each side, the bumps B1 and B2 on the wheel rim TR1 keep the tire from slipping back when the pressure is low. Although helpful, this beadlock system is not sufficient for the forces required for many off-road applications.

Another common prior design of a beadlock system is to have an external ring ER bolted with an internal ring IR inside the tire, so the tire wall is captured on the tire rim TR2 as shown in the outside beadlock system illustrated in FIG. 2. This outside beadlock system functions, but is limited to one side of the tire (the typically outside), and is heavy.

### SUMMARY

An internal double beadlock system includes a centralized inner ring and one or more tire positioners. The one or more tire positioners are coupled to extend out from each side of the centralized inner ring. Each of the tire positioners has a length to detachably engage with a portion of an inner tire wall on each side of a tire positioned on a tire rim while being shorter than a width of the tire rim.

A method for making an internal double beadlock system includes providing a centralized inner ring and coupling one or more tire positioners to extend out from each side of the centralized inner ring. Each of the tire positioners has a length to detachably engage with a portion of an inner tire wall on each side of a tire positioned on a tire rim while being shorter than a width of the tire rim.

A method for installing a tire on a rim includes coupling a centralized ring of an internal double beadlock system to a central portion of a tire rim. One or more tire positioners extend out from each side of the centralized inner ring. Each of the tire positioners has a length to detachably engage with a portion of an inner tire wall on each side of a tire positioned on a tire rim while being shorter than a width of the tire rim. The end portion of the tire wall on each side of the tire is positioned in a space between each end of the tire positioners and outer edges of the tire rim to form a detachable engagement and then at least partially inflating the tire.

Examples of this technology provide a number of advantages including providing a secure, lightweight, and effective wheel-internal double beadlock system suitable for all types of driving applications. With examples of this technology, the wheel-internal double beadlock system is advantageously designed to keep both sides of the tire in place (inside and outside sides) at any tire pressure. As a result, both walls of the tire are supported internally and will not come off their position. Additionally, with examples of the technology the wheel-internal double beadlock system has less weight and overall cost than the outside beadlock systems. Further, with examples of this technology, high air pressure is not required to seat the tire “over” the bumps, as is required for the traditional beadlock system (which can be difficult and dangerous).

### BRIEF DESCRIPTION OF THE DRAWINGS

FIG. 1 is a cross-sectional side view of a traditional prior art beadlock system.

FIG. 2 is an exploded view of a prior art outside beadlock system.

FIG. 3 is a perspective view of an example of a wheel-internal double beadlock system.

FIG. 4 is a side view of the example of the wheel-internal double beadlock system shown in FIG. 3.

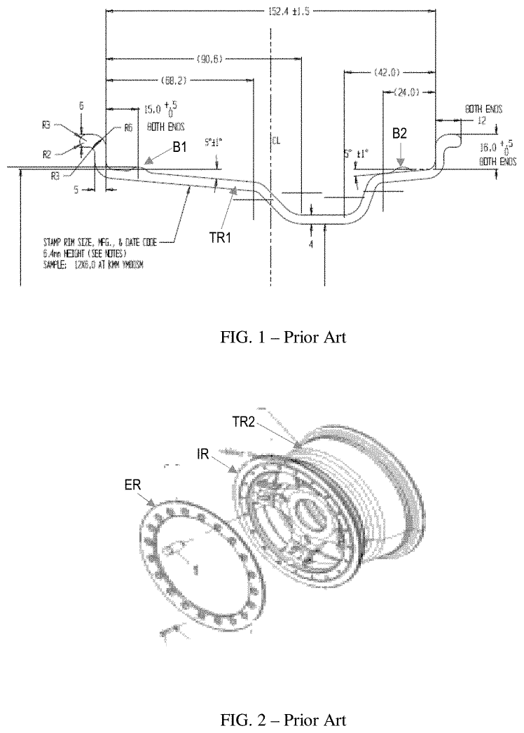

### DETAILED DESCRIPTION

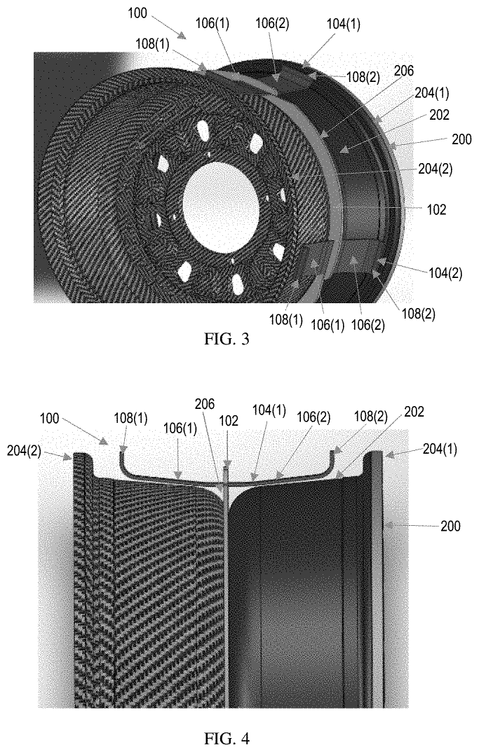

An example of a wheel-internal double beadlock system 100 is illustrated in FIGS. 3 and 4. In this particular example, the wheel-internal double beadlock system 100 includes a centralized inner ring 102 and four tire positioners, two of the tire positioners 104(1)-104(2) which are visible in FIG. 3, although the system could have other types and/or numbers of these and/or other components and/or elements in other configurations. Examples of this technology provide a number of advantages including providing a secure, lightweight, and effective wheel-internal double beadlock system suitable for all types of driving applications at any tire pressure.

Referring more specifically to FIGS. 3 and 4, the centralized inner ring 102 comprises a band which in this example is detachably secured within a centralized groove 206 of a surface 202 of a tire rim 200, although the centralized inner ring 102 could comprise other types and/or numbers of components and/or elements in other configurations and be connected in other manners. Additionally, the centralized inner ring 102 extends out from the surface 202 of the tire rim 200 in this example to provide a convenient surface area to permanently or detachably secure the tire positioners.

This example of the wheel-internal double beadlock system 100 has four tire positioners, two of the tire positioners 104(1)-104(2) are visible in FIG. 3, although other types and/or lesser or greater numbers of tire positioners may be used. The four tire positioners are equally spaced about the centralized inner ring 102 and, if other numbers of tire positioners are used, then the tire positioners would be equally spaced about the centralized inner ring 102. Additionally, in this example, the tire positioners are detachably coupled to the centralized inner ring 102 to allow customization with respect to the number of tire positioners used as well as with respect to the positioning of each of the tire positioners to enable further customization for adjusting to different driving conditions and requirements, although the attachment of one or more of the tire positioners could be fixed.

In this example, the structure and operation of the four tire positioners is the same, so for ease of discussion the following exemplary description references tire positioners 104(1)-104(2) and that description is applicable to the other tire positioners not visible in these figures. Each of the tire positioners 104(1)-104(2) are coupled to extend out perpendicularly from each side of the centralized inner ring 102, although the tire positioners 104(1)-104(2) could be coupled to extend out in other orientations. Each of the tire positioners 104(1)-104(2) also has a length shorter than a width of the tire rim 200, but long enough to detachably engage with a portion of an inner tire wall on each side of a tire (not shown). An outer wall of on each side of the tire (not shown) engages with tire rim edges 204(1) and 204(2) of tire rim 200 to provide the double beadlock on both sides of the tire. Further, each portion of the tire positioners 104(1)-104(2) extending out from the centralized inner ring 102 is spaced from the surface of the tire rim 200 and comprises on each side an elongated arm 106(1) and 106(2) with an end engagement section 108(1) and 108(2) that each extend in a different direction from the elongated arm 106(1) and 106(2) and the surface 202 of the tire rim 200 to be positioned to face a portion of an inner tire wall on each side of the tire (not shown) and provide a matching surface size, in this example, to engage and retain the tire. In this example, the elongated arms 106(1) and 106(2) and end engagement section 108(1) and 108(2) comprise one piece, although in other could be separate elements which are coupled together. Each of the tire positioners 104(1)-104(2) is also sized and shaped to provide a level of spring tension on an inner wall of each side of a tire (not shown) that in conjunction with the engagement of the tire rim edges 204(1) and 204(2) of tire rim 200 with an outer wall of each side of the tire (not shown) retains the tire on the rim under any tire pressure including for example no pressure. By way of example, the shape and/or size of the elongated arms 106(1) and 106(2) could be customized to provide different levels of spring tension. With these elongated arms 106(1) and 106(2) with a customized level of spring tension, one or more of the tire positioners could be replaced to customize a level of spring tension for particular applications and conditions.

An example of a method for making a wheel-internal double beadlock system 100 will now be described with reference to FIGS. 3 and 4. In this example, a centralized inner ring 102 which can be attached to a surface 202 of a tire rim 200 is provided. Four tire positioners, two of the tire positioners 104(1)-104(2) are visible in FIG. 3, are detachably coupled to extend out from each side of the centralized inner ring 102. The tire positioners may be coupled to the centralized inner ring 102 before or after installation of the centralized inner ring 102 on the tire rim 200. As discussed above, each of the tire positioners has a length to detachably engage with a portion of an inner tire wall on each side of a tire (not shown) positioned on a tire rim 200 while being shorter than a width of the tire rim 200.

An example of a method for installing a tire on a rim will now be described with reference to FIGS. 3 and 4. In this example, a centralized inner ring 102 of a wheel-internal double beadlock system 100 is detachably secured to a surface 202 of a tire rim 200, although the system could be secured in other locations and manner, such as a fixed securement to the tire rim 200 by way of example. One or more tire positioners, two of the tire positioners 104(1)-104(2) are visible in FIG. 3, are detachably coupled to extend out from each side of the centralized inner ring 102 and are equally spaced about the centralized inner ring 102, although other attachments and configurations may be used. With examples of this technology, the number of and position of each of the tire positioners on the centralized inner ring 102 can be customized to suit the particular driving application. As discussed earlier, each of the tire positioners has a length to detachably engage with a portion of an inner tire wall on each side of a tire (not shown) positioned on a tire rim 200 while being shorter than a width of the tire rim 200. The end portion of the tire wall on each side of the tire is positioned in a space between each end of the tire positioners, two of the tire positioners 104(1)-104(2) are visible in FIG. 3, and outer rim edges 204(1) and 204(2) of the tire rim 200 to form a detachable engagement and then at least partially inflating the tire.

Accordingly, as illustrated and described herein, examples of this technology provide a number of advantages including providing a secure, lightweight, and effective wheel-internal double beadlock system suitable for all types of driving applications. Additionally, with examples of this technology, the wheel-internal double beadlock system is advantageously designed to keep both sides of the tire in place (inside and outside sides) at any tire pressure. As a result, both walls of the tire are supported internally and will not come off their position. Further, with examples of the technology the wheel-internal double beadlock system has less weight and overall cost than the outside beadlock systems. Even further, with examples of this technology, high air pressure is not required to seat the tire “over” the bumps, as is required for the traditional beadlock system (which can be difficult and dangerous)

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. An internal double beadlock system comprising:
a centralized inner ring; and
one or more tire positioners coupled to extend out from each side of the centralized inner ring, wherein each of the tire positioners has a length to detachably engage with a portion of an inner tire wall on each side of a tire positioned on a tire rim while being shorter than a width of the tire rim.

2. The system as set forth in claim 1 wherein each portion of the one or more tire positioners extending out from the centralized inner ring is spaced from the tire rim and comprises an elongated arm with an end engagement section that extends in a different direction from the elongated arm to be positioned to face the tire bead on each side of the tire.

3. The system as set forth in claim 2 wherein each of the elongated arms is configured to provide a spring tension on the portion of the tire wall on each side of the tire.

4. The system as set forth in claim 1 wherein the centralized inner ring is shaped to fit within a centralized groove the tire rim.

5. The system as set forth in claim 1 wherein the one or more tire positioners further comprise:
at least four of the tire positioners are coupled to the centralized inner ring, wherein the at least four of the tire positioners are equally spaced apart along the centralized inner ring.

6. A method for making an internal double beadlock system, the method comprising:
providing a centralized inner ring; and
coupling one or more tire positioners to extend out from each side of the centralized inner ring, wherein each of the tire positioners has a length to detachably engage with a portion of an inner tire wall on each side of a tire positioned on a tire rim while being shorter than a width of the tire rim.

7. The method as set forth in claim 6 wherein each portion of the one or more tire positioners extending out from the centralized inner ring is spaced from the tire rim and comprises an elongated arm with an end engagement section that extends in a different direction from the elongated arm to be positioned to face the tire bead on each side of the tire.

8. The method as set forth in claim 7 wherein each of the elongated arms is configured to provide a spring tension on the portion of the tire wall on each side of the tire.

9. The method as set forth in claim 6 wherein the centralized inner ring is shaped to fit within a centralized groove the tire rim.

10. The method as set forth in claim 6 wherein coupling one or more tire positioners to extend out from each side of the centralized inner ring further comprises:
coupling at least four of the tire positioners to the centralized inner ring, wherein the at least four of the tire positioners are equally spaced apart along the centralized inner ring.

11. A method for installing a tire on a rim, the method comprising:
coupling a centralized ring of an internal double beadlock system to a central portion of a tire rim, wherein one or more tire positioners extend out from each side of the centralized inner ring and each of the tire positioners has a length to detachably engage with a portion of an inner tire wall on each side of a tire positioned on a tire rim while being shorter than a width of the tire rim;
position the end portion of the tire wall on each side of the tire in a space between each end of the tire positioners and outer edges of the tire rim to form a detachable engagement; and
at least partially inflating the tire.

12. The method as set forth in claim 11 wherein each portion of the one or more tire positioners extending out from the centralized inner ring is spaced from the tire rim and comprises an elongated arm with an end engagement section that extends in a different direction from the elongated arm to be positioned to face the tire bead on each side of the tire.

13. The method as set forth in claim 12 wherein each of the elongated arms is configured to provide a spring tension on the portion of the tire wall on each side of the tire.

14. The method as set forth in claim 11 wherein the centralized inner ring is shaped to fit within a centralized groove the tire rim.

15. The method as set forth in claim 11 wherein the one or more tire positioners coupled to extend out from each side of the centralized inner ring further comprises:
at least four of the tire positioners coupled to the centralized inner ring, wherein the at least four of the tire positioners are equally spaced apart along the centralized inner ring.
